(19) United States
(12) Patent Application Publication
(10) Pub. No.: US 2022/0374630 A1
(43) Pub. Date: Nov. 24, 2022

(54) PERSON RE-IDENTIFICATION SYSTEM AND METHOD INTEGRATING MULTI-SCALE GAN AND LABEL LEARNING

(71) Applicant: Guangxi Academy of Science, Nanning City (CN)

(72) Inventors: Deshuang Huang, Shanghai (CN); Kun Zhang, Shanghai (CN); Yong Wu, Anqing City (CN); Changan Yuan, Nanning City (CN)

(21) Appl. No.: 17/401,681

(22) Filed: Aug. 13, 2021

(30) Foreign Application Priority Data
May 11, 2021 (CN) 2021105090199

(51) Int. Cl. G06K 9/00; G06K 9/62; G06N 3/08; G06N 3/04

(52) U.S. Cl. CPC G06K 9/00362; G06K 9/6232; G06K 9/6256; G06N 3/088; G06N 3/0481; G06N 3/0454

(57) ABSTRACT

A person re-identification system and a person re-identification method integrating multi-scale GAN and label learning are provided. The occluded blocks with different sizes are added to an original image for data restoration and enhancement, multi-scale discrimination branches are introduced, multi-scale features are fused, and feature matching losses on different scales are calculated respectively to improve the quality of generative images. Further, an online label learning method based on semi-supervised learning is provided to label a generative image and reduce the interference of label noise on an identification model.

### TECHNICAL FIELD OF THE INVENTION

The invention relates to the field of person re-identification, in particular to a person re-identification system and method integrating multi-scale GAN (Generative Adversarial Network) and label learning.

### BACKGROUND OF THE INVENTION

In the early research of person re-identification, researchers mainly used artificial construction to express features and select metric functions. With the improvement of computer performance, deep network-based research has gained great success in the field of image processing. Since then, deep learning-based research method has become one of the mainstream research methods in the field of person re-identification.

Deep network-based models can automatically extract the high-order semantic features of images, making the identification performance efficient and accurate. In recent years, many effective techniques have been put forward in the field of computer vision to improve the effect of models. In terms of data enhancement, generative adversarial networks are widely used, and many scholars have designed various network frameworks based on different data characteristics and task objects. In terms of feature extraction, as global feature extraction techniques become increasingly mature, scholars have recognized the limitations of using global features alone, and started to focus on local features, hoping to acquire more effective local features by various ways such as multi-scale learning, attention mechanism and the like.

However, it is still a challenging task to use these methods effectively in person re-identification tasks. The difficulties in migrating these techniques to person re-identification are as follows: (1) deep network needs a large amount of data for training, but current public datasets of person re-identification cannot meet the training requirements, which can easily make the model over-fitted; (2) the high-order semantic features extracted from deep network often pay special attention to certain local information, and the possible occlusion of person images may affect the extraction of these features, thus affecting the identification performance of the model.

To sum up, aiming at the task of person re-identification, it is required to investigate methods that can alleviate the impact of insufficient data and effectively use local features, which is of great significance to improving performance of person re-identification modules.

GAN-based data enhancement method has been widely used in the computer field. However, there are still some problems: (1) since the GAN generator inputs a random noise pattern, the style type of the generative image cannot be controlled, and the quality of the generative image is not high; (2) since the generative images are not directly associated with the samples in the training set, they cannot be classified, but can only be used as unsupervised data-assisted networks for pre-training most of the time.

Therefore, there is an urgent need for a method that can solve the problems in the prior art.

### SUMMARY OF THE INVENTION

The invention intends to provide a person re-identification system and method integrating multi-scale GAN and label learning, so as to solve the problems existing in the prior art.

To achieve the above purpose, the invention provides the following technical solutions:

The invention provides a person re-identification system integrating multi-scale GAN and label learning. The system includes a generative network, a discriminant network, a loss function module and a label learning module, and the generative network is connected to the discriminant network;

the generative network includes a U-Net sub-network for restoring occluded images and expanding datasets;

the discriminant network includes a Markov discriminator and a multi-scale discriminator;

the Markov discriminator is configured (i.e., structured and arranged) for extracting regional features;

the multi-scale discriminator is used for extracting multi-scale features;

the generative network inputs an occluded image added to an original image and outputs a generative image; and

the discriminant network inputs the generative image and the original image.

Furthermore, the generative network uses an Encoder-Decoder structure;

wherein the Encoder includes, but is not limited to, a plurality of first convolutional layers, and the first convolutional layer is used for downsampling and encoding an input; the Decoder includes, but is not limited to, a plurality of deconvolutional layers, and the deconvolutional layer is used for upsampling and encoding the encoded information.

Furthermore, the U-Net sub-network is further used for adding jump connections between the Encoder and the Decoder, and the jump connections between first two layers are deleted from the U-Net sub-network.

Furthermore, the convolutional layer and the deconvolutional layer adopt the same convolution kernel with a size of 4 and a step size of 2.

Furthermore, the Markov discriminator includes, but is not limited to, a plurality of second convolutional layers, a batch normalization layer and an activation function; the second convolutional layer downsamples the original image, reduces the size of feature map and increases the receptive field at each location; the activation function is Sigmoid; and the Markov discriminator discriminates the same region once or many times.

Furthermore, the loss function module includes a GAN loss, an L1 norm loss and a feature matching loss;

wherein the GAN loss is used for optimizing the ability of the discriminant network to discriminate the authenticity of an image; and the L1 norm loss and the feature matching loss are used for reducing a difference between the generative image and a target image in pixel dimension and feature dimension.

Furthermore, the label learning module uses an improved multi-pseudo regularized label for label learning, with the improvements as follows: constructing the label distribution in a smoothed manner, updating labels in preset training rounds, introducing random factors while updating, and retaining some of the original labels based on the random factors.

A person re-identification method integrating multi-scale GAN and label learning, specifically includes the following steps:

S1, constructing a multi-scale conditional generative adversarial network, wherein the multi-scale conditional generative adversarial network includes a generator and a discriminator, acquiring an original person image, performing normalization processing, and adding an occlusion to the original person image to obtain an occluded person image;

S2, inputting the occluded person image to the generator that restores the occluded person image and outputs a generative image; and adding a label to the generative image for label learning;

S3, inputting the labeled generative image and the original person image into the discriminator, wherein the discriminator extracts feature regions and multi-scale features from the labeled generative image, calculates comparison results between the extracted feature regions, multi-scale features and the original person image based on a loss function, obtains loss values, and optimizes and updates parameters of the generator based on the loss function; and

S4, iterating S3 until the number of iterations reach a preset value, then completing the identification.

Furthermore, the specific method of label learning is to conduct online label learning through an improved MPRL, and reduce noise interference caused by the generative image.

The invention discloses the following technical effects:

To solve the problem of low quality of generative images at present, the invention provides a multi-scale conditional generative adversarial network based on occluded images, which enhances data by adding occluded blocks of different sizes to an original image and restoring the same, and introducing conditional information to enhance the quality of generative images. Further, the invention provides an automatic label learning method to reduce the interference of wrong labeling on the model.

Based on the conditional generative adversarial network, the multi-scale discriminant branch is introduced, the multi-scale features are fused, and the feature matching losses on different scales are calculated respectively to improve the quality of generative images.

By comparing several label learning methods, an online label learning method based on semi-supervised learning is proposed to label a generative image appropriately and reduce the interference of label noise on the identification model.

### BRIEF DESCRIPTION OF THE FIGURES

To explain more clearly the embodiments in the invention or the technical solutions in the prior art, the following will briefly introduce the figures needed in the description of the embodiments. Obviously, figures in the following description are only some embodiments of the invention, and for a person skilled in the art, other figures may also be obtained based on these figures without paying any creative effort.

FIG. 1 is a structural schematic diagram of the multi-scale conditional generative adversarial network according to an embodiment of the invention.

FIG. 2 is a schematic diagram of the convolution module (top) and the deconvolution module (bottom) according to an embodiment of the invention.

FIG. 3 a structural schematic diagram of the generative network according to an embodiment of the invention.

FIG. 4 is a structural schematic diagram of the Markov discriminant branch according to an embodiment of the invention.

FIG. 5 is a structural schematic diagram of the multi-scale discriminant branch according to an embodiment of the invention.

FIG. 6 shows an effect of a parameter M on the identification result according to an embodiment of the invention.

### DETAILED DESCRIPTION OF THE PREFERRED EMBODIMENTS

Various exemplary embodiments of the invention will now be described in detail, which should not be construed as being limited thereto, but should be understood as a more detailed description of certain aspects, features and embodiments thereof.

It should be understood that the terms described herein are only intended to describe specific embodiments, and are not intended to limit the invention. Furthermore, the range of values in the invention should be such understood that each intermediate value between the upper and lower limits of the range is also specifically disclosed. Each smaller range between any stated value or intermediate value within a stated range and any other stated value or intermediate value within a stated range is also included in the invention. The upper and lower limits of these smaller ranges can be independently included in or excluded from the scope.

Unless otherwise indicated, all technical and scientific terms used herein have the same meaning as commonly understood to one of ordinary skill in the art to which the invention belongs. Although the invention describes only preferred methods and materials, any methods and materials similar or equivalent to those described herein can be used in the practice or testing of the invention. All literatures mentioned herein are incorporated herein by reference for the purpose of disclosing and describing the methods and/or materials associated with the literatures. In the event of a conflict with any incorporated literature, the contents of this specification shall prevail.

It will be readily apparent to those skilled in the art that various modifications and changes can be made to the specific embodiments of the specification of the invention without departing from the scope or spirit of the invention. Upon reading the invention, many alternative embodiments of the invention will be apparent to persons of ordinary skill in the art. The specification and examples of the invention are only exemplary.

As used herein, the terms “including”, “comprising”, “having” and “containing” are all open terms, which means including but not limited to.

The “parts” mentioned in the invention are by mass unless otherwise specified.

The content of this embodiment includes two aspects, i.e. multi-scale GAN-based image generation and label learning of the generative image. Conditional GAN-based image generation can control the style type of the generative images and improve the image quality by introducing conditional information. Label learning, on the other hand, can assign appropriate labels to the generative images, and allow them to participate in the network training process. The invention firstly explores conditional information GAN-based network structure, on the basis of this, proposes a multi-scale generative adversarial network, constructs occluded images as conditional information input network, and enhances the dataset using the restored images. Then, appropriate labels are assigned to the generative images by comparing a variety of label learning methods. Finally, the person data enhancement method based on multi-scale GAN and label learning are tested by multiple datasets to demonstrate the effectiveness of the invention.

### Example 1

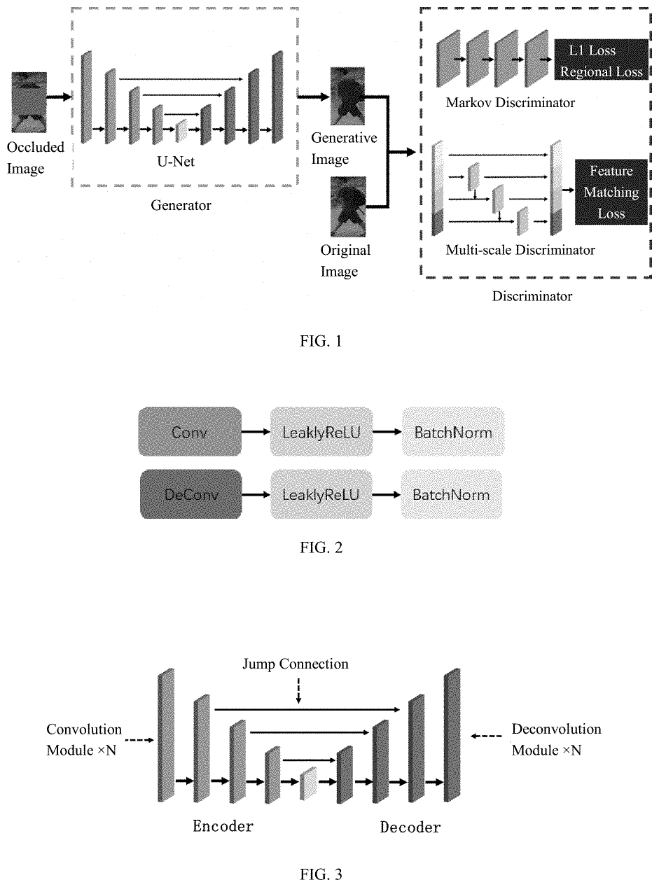

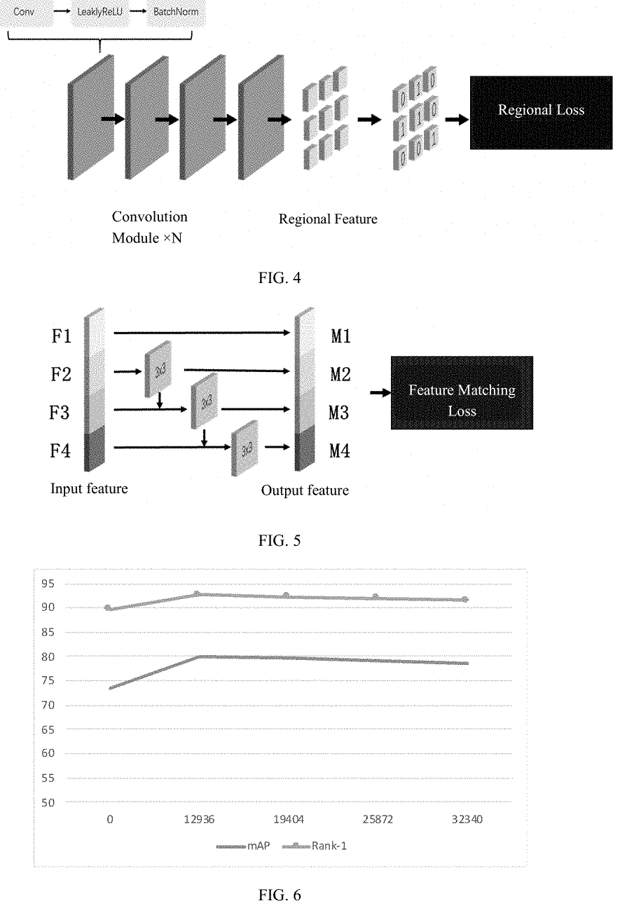

The structure of the multi-scale generative adversarial network proposed by the invention is shown in FIG. 1. Based on the conditional generative adversarial network, the network uses an occluded person image as conditional information, deletes part of the jump connection U-Net network as the generator, and restores the occluded image. The discriminator includes two branches: a Markov discriminator and a multi-scale discriminator, wherein the Markov discriminator is used for extracting regional features and calculating L1 loss and regional loss, and the multi-scale discriminator is used for extracting multi-scale features and calculating the feature matching loss.

The Pixel-To-Pixel GAN(pix2pix) structure is a network proposed by Phillip Isola in 2016 to solve the paired editing task of images. The paired editing task of images, also known as image translation task, refers to the image-to-image conversion task, i.e. converting an input image into a target image, which is somewhat similar to style transfer but more demanding. The Pix2pix model is improved from the conditional generative adversarial network; for example, for a task that originally relies on L1/L2 loss alone, a GAN structure is introduced by fusing L1/L2 loss and GAN loss, which is proved effective by experiments on several datasets. The primary function of the Pix2pix model is to adjust the loss function according to the task requirements, reconstruct the input pairs, and introduce the GAN structure into various tasks. Based on this idea, in the invention an occluded block is added to a person image, and the occluded image and an original image are input into the network for training, thus enhancing the dataset by using a de-occluded image.

The Pix2pix model has tried to use only L1/L2 loss, only GAN loss and fusing L1/L2 loss and GAN loss on various tasks. Through experiments, it is found that using L1/L2 loss only will lead to a blurred image and loss of high frequency information. In contrast, GAN loss can retain the high-frequency information well, but it will lead to a big difference between the generative image and the input image. The optimal solution is to fuse L1 loss and GAN loss, for example, use L1 loss to capture low-frequency information, and model high-frequency information through the GAN discriminant network to get a high-quality output image.

In terms of generative network, the Pix2pix model adopts an Encoder-Decoder structure as a generative network. As described above, the Encoder network is mainly composed of convolutional layers that downsample and encode an input, while the Decoder network is composed of deconvolutional layers that upsample and decode the coded information. In this process, key underlying information will be encoded and retained, and transmitted from an input to an output, but a lot of details will be lost. These details are very important for high-precision tasks such as image translation. Therefore, the U-NET structure is added to the generative network, and the jump connection is added between the Encoder network and the Decoder network to retain the detailed features. Specifically, for the n-layer generative network, an information channel will be added between the i^{th} layer and the n-i^{th} layer to directly pass the uncoded features.

The discriminant network is built by the module of “convolutional layer-batch normalization layer-ReLU activation function”, and adopts a PatchGAN structure based on the Markov discriminator. A traditional discriminant network directly outputs a judgment on the authenticity of an image, while PatchGAN downsamples the image through convolution, and outputs an N*N feature map, in which each position corresponds to an area of the original input (i.e., the output of the generative network) according to the size of convolution receptive field, and the value on the feature map indicates whether the position is true or false. PatchGAN forces the network to model the high-frequency feature structure by limiting the attention of the network to be a local region. Through several experiments, it is demonstrated that the PathGAN structure can still generate high-quality images even if the local region used for modeling is much smaller than the original input. Building a network based on small regions reduces the amount of computation and improves the running speed of the network, and can be extended to operate on images of arbitrary size.

Generative Network:

The task of generative network is to generate images by combining conditional information, i.e., to restore occluded parts of an occluded image. The generative network used in the invention adopts an Encoder-Decoder structure, and the Encoder is composed of convolution modules, as shown in FIG. 2, wherein the LeaklyReLU function is a variant of the activation function ReLU, and expressed as:

$${f}_{l - relu} ( x ) = \{ \begin{matrix}\begin{matrix}x & x \geq 0\end{matrix} \\ \begin{matrix}ax & x < 0\end{matrix}\end{matrix} \qquad ( 1 )$$

where, α denotes the slope of the LeaklyReLU function in the negative part, which is usually a small positive number. Through a contrastive analysis on the expression of ReLU function, we know that an improvement is mainly in the negative part. Different from ReLU function which outputs 0 between negative parts to make the gradient disappear, LeaklyReLU function keeps a smaller gradient in negative parts and alleviates the phenomenon of gradient disappearance.

Batch normalizing intends to solve an internal covariant offset. For deep networks, the operation of each layer will change the distribution of input data, and the distribution changes will be superimposed continuously with the increase of network layers, making the distribution changes increasingly intense with the increase of network layers. Therefore, normalizing operations should be performed on the output of each layer to maintain a consistent distribution. The batch normalizing, on the other hand, is to perform a normalizing operation on the data of each batch by means of mean and variance variables, and update the variables.

Decoder is mainly composed of deconvolution modules structurally similar to a convolutional layer, and the deconvolution module includes deconvolutional layers instead of convolutional layers, and performs up-sampling operation instead of down-sampling operation.

As shown in FIG. 3, the generative network includes N convolution modules as an Encoder and N deconvolution modules as a Decoder, wherein each module adopts the same convolution kernel with a size of 4 and a step size of 2. In the invention, the U-Net structure is introduced into the generative network; but unlike the traditional U-Net structure, jump connections are not added between all levels of the Encoder and Decoder. As shown in FIG. 3, the U-Net is constructed by deleting the jump connections in the first two layers, so as to avoid premature convergence of the model due to the leakage of label information.

Most of the image translation tasks are the overall style change like content generation and color change, so the original image features shall be passed to the image completely. However, the task of the invention is to occlude part of an image first, with an eye to restoring the occluded image by the generative network. When the occlusion region is small, the input image and the output image are consistent in most regions. If the features of the original image are directly passed to the Decoder through jump connection, the model will tend to use the original information directly and converge prematurely, and the network parameters will not be fully trained and updated. Therefore, the jump connections of the first two layers are deleted, and only the semantic features extracted from the network are passed, which increases the difficulty of training and enhances the performance of the network; at the same time, some random factors are introduced, making the generative image somewhat different from the original image in terms of overall style.

Discriminant Network:

In traditional GAN networks, the goal of the discriminant network is to judge the authenticity of the entire input image. In the invention, since only some areas of the image are occluded, it is more necessary for the network to be able to judge the authenticity of each local area than the global area. Using a Markov discriminator, features are extracted from the original image by convolution, and are divided into N*N regions to judge the authenticity of each region separately; at the same time, a multi-scale feature learning structure is added to extract multi-scale features.

The Markov discriminator is composed of N convolution modules, and adopts Sigmoid activation function. Like the generative network, the convolution module is composed of convolutional layers, LeakReLU and BatchNorm. The original image is successively downsampled by multiple convolutional layers to reduce the size of feature map and increase the receptive field at each location. Here, the parameters of the pix2pix model are used, and the size of receptive field corresponding to each position of the final feature map is 70*70. It should be noted that the final receptive fields of N*N regions are not independent of each other, but have a large part of intersection regions, so the structure can discriminate the same region for many times so that the network parameters can be fully trained.

Since the size of the receptive field of the feature map finally output by the Markov discriminator is fixed, the information scale obtained is relatively simple. The multi-scale feature extraction technique can help the network to obtain feature information on different scales. In the invention, the multi-scale feature learning branch is added to the discriminant network; as shown in FIG. 5, the feature map output by the third convolution module in the Markov Discriminator is divided into four feature maps through multiple groups of 1*1 convolution kernels, and multiple groups of 3*3 convolution kernels are used to extract the loss of each feature map on different scales, and trained separately. Specifically, in the invention, the i^{th} feature map is defined as Fᵢ, and the corresponding feature is Mᵢ, i∈{1,2,3,4}. The computational formula of the feature Mᵢ is:

$${M}_{i} = \{ \begin{matrix}{F}_{i} & i = 1 \\ Conv ( {F}_{i} ) & i = 2 \\ Conv ( {M}_{i - 1} + {F}_{i} ) & i > 2\end{matrix} \qquad ( 2 )$$

It can be seen that in the multi-scale feature learning branch, features containing different receptive fields are output and separated by different convolution combinations and feature fusion. In the invention, features M₁ and M₂ are spliced to obtain a feature M₁₂, which is called a small-scale convolution feature that has a small receptive field and contains more local details of persons; whereas, features M₃ and M₃ are spliced to obtain a feature M₃₄, which is called a large-scale convolution feature that has a large receptive field due to multiple groups of convolutions and contains spatial information on the global scale. Persons can be described from different perspectives by separating large scale features from small scale features.

Loss Function:

The loss function mainly includes three parts: GAN loss, L1 norm loss and feature matching loss. As described above, the loss function represents the optimization goal of the neural network. The GAN loss aims to optimize the discriminator so that the discriminator can better distinguish the authenticity of the input image, thus indirectly optimizing the generator. In general, the GAN loss is a classic loss of GAN network structure. The L1 norm loss and the feature matching loss intend to make the generative image and target image closer, and measure the difference between the two in pixel dimension and feature dimension respectively. Firstly, the GAN loss is introduced. As a result of the conditional generative adversarial network, the function of corresponding conditional GAN loss is shown in Formula (3), where, x,y,z represent a real image, conditional information and a random noise respectively, G network represents a generative network, a desirable maximum loss, and D network represents a discriminant network, a desirable minimum loss.

L_{cGAN}(G,D)= [symbol] _{x,y}[log D(x|y)]+ [symbol] _{z,y}[log(1−D(x,G(z|y)))] (3)

In contrast to the original GAN loss, all expectations of conditional GAN loss are calculated based on the conditional probability. In the task of image translation, the conditional information is the input image, and the image label is the target image.

As mentioned above, the discriminant network uses the Markov discriminant, and finally outputs the prediction result of N*N regions. Therefore, in calculating the loss, these regions shall be calculated separately, and then the average value is taken as the final result.

In measuring the difference between the generative image and the target image, the most intuitive way is to compare the pixel difference between the two, and L1 loss and L2 loss are commonly used as a measure of the pixel difference between the two images. Compared with L2 loss, L1 loss has some advantages, for example, obvious edge of the image produced by L1 loss training, and high sharpness of the image. Thus, L1 loss is used finally and expressed as:

L_{L1}(G)= [symbol] _{x,y,z}[∥y−G(x,z)∥₁] (4)

L1 loss can directly measure the difference of images as a whole, and cannot focus on important information. However, for person images, person regions are more important than background regions, and attribute detail features of person regions are more important than other features, which cannot be measured by L1 loss though. To make up for these disadvantages of L1 loss, according to the invention a multi-scale feature learning branch is introduced into the discriminant network, and small-scale features are separated from large-scale features to extract semantic information of person images on different scales; meanwhile, the difference between the target image and the generative image in the corresponding scale is measured by the feature matching loss L_{F}, which is expressed as:

L_{F}(G,D)= [symbol] _{x,y,z}[αₛL_{W}_{ₛ}(D(y)_{SSF},D(G(x,z))_{SSF})+α_{L}L_{W}_{_{L}}(D(y)_{LSF},D(G(x,z))_{LSF})] (5)

L_{W}(p,q)=(p−q)^{T}W(p−q) (6)

where, αₛ and α_{L} are weight coefficients, D(y)_{SSF} and D(G(x,z))_{SSF} represent the small-scale features of the target image and the generative image respectively, D(y)_{LSF} and D(G(x,z))_{LSF} represent the large-scale features of the target image and the generative image respectively, and L_{W} is a distance measurement function of different scale features based on Mahalanobis distance. Therefore, the final objective function is:

$${G}^{*} = arg {min}_{G} {max}_{D} {L}_{cGAN} ( G , D ) + {λ}_{1} {L}_{L 1} ( G ) + {λ}_{2} {L}_{F} ( G , D ) \qquad ( 7 )$$

Label Learning:

The invention describes some traditional label allocation modes of generative images, and provides a label learning framework based on semi-supervised learning.

In the previous section, the structure design of multi-scale generative adversarial networks is discussed. Since the person re-identification framework models used at present are all based on supervised learning, appropriate labels shall be added to the generative images if the generative images are to be extended to the dataset. The invention describes the offline label learning methods LSRO and LSR firstly, and then describes and improves the MPRL based on online learning.

### (1) Label Allocation Based on Label Smoothing

In the early processing, the generative images were labeled as the same category or randomly labeled as a certain category. Considering that this method is easy to introduce excessive noise, Zheng et al. proposed a label smoothing regularization for outliers (LSRO). LSRO draws on the idea of label smoothing, and assumes that the generative image does not belong to any category in the dataset, and uniformly distributed in all categories. Therefore, the same probability value is assigned to all categories of the generated samples, as shown in Formula (8), assuming that there are K types of samples, the probability of the generative image on each type of sample is 1/K.

$${q}_{LSRO} ( k ) = \frac{1}{K} \qquad ( 8 )$$

Different from the method of randomly allocating labels to the generative images or marking them in the same category, LSRO treats the generative images as outlier samples, and makes those images contribute evenly in each category, with the aim of encouraging the network to find more potential high-frequency features, and enhancing the generalization ability of the network, and making the network less prone to overfitting. However, due to strong hypothesis, when there are a large number of generative images, it will introduce too much noise and affect the convergence of the network; hence, LSRO is more suitable for scenes using a small number of generated samples.

As the conditional generative adversarial network becomes popular, the content and style of generative images can be controlled according to conditional information, and the category of conditional information can also be referenced when labels are allocated. The previous study states that the generative image is highly associated with the conditional information, so a label smoothing regularization (LSR) method is directly used to allocate probabilities of different categories to the generative image, and the specific expression is shown in Formula (9):

$${q}_{LSR} ( k ) = \{ \begin{matrix}\begin{matrix}1 - ε + \frac{ε}{K} & k = y\end{matrix} \\ \begin{matrix}\frac{ε}{K} & k \neq y\end{matrix}\end{matrix} \qquad ( 9 )$$

where, ε is a hyper-parameter taken in the range [0,1], which controls the degree of smoothness. When ε is 0, it is equivalent to one-hot label; and when ε is 1, it is equivalent to q_{LSRO}. Compared with the LSRO, LSR assigns a higher confidence level to the corresponding categories due to the consideration of conditional information, which mitigates the noise caused by the generated samples, and facilitates the convergence of the network. Further, as some random noise is introduced into the generative image, a certain probability is reserved for other categories to ensure that the network has certain generalization ability.

### (2) Label Learning Based on Semi-Supervised Learning

As mentioned above, LSRO and LSR belong to offline allocation modes, i.e., labels are allocated to each type of generative images before training through certain assumptions. However, this method of assigning the same probability to the same kind of generative images is often inconsistent with the reality, especially for the restored occluded images, the probability distribution in different categories should be different due to the difference of occlusion region size and occlusion position, and the offline allocation mode does not take these differences into account. In view of these factors, Yang et al. proposed a multi-pseudo regularized label (MPRL). On the basis of offline label allocation, MPRL continuously updates the labels of iterative generated samples during the training process. Specifically, for each generated sample, the sample label is updated and iterated several times according to the output probability of each network. The update method is shown in Formula (10):

$${q}_{MPRL} ( k ) = \frac{{α}_{k}}{K} \\ ( {α}_{k} = Φ ( p ( {X}_{k} ) , {sort}_{min \to max} ( p ( X ) ) ) ) \qquad ( 10 )$$

where, p(Xₖ) represents the probability of categories, sort_{min→max}(p(X)) represents the sorting sequence of all categories from small to large, and Φ(⋅) represents returning to the index position in the list. Compared with offline allocation, MPRL draws on the idea of semi-supervised learning, helps to label the generated samples by using the real labeled data, and assigns different labels to different samples combined with the differences between generated samples. Further, the real labeling data is also used to assign more reasonable labels to the generated samples.

However, in the actual experimental process, MPRL has two drawbacks: (1) when the label is updated by Formula (10), the probability of the category located in the same ordinal number is fixed, which limits the probability distribution of sample labels, and makes the difference of probability between categories not obvious; and for actual samples, more than 90% of the probabilities are concentrated in only a few categories; (2) although updating labels through the results of network prediction can accelerate the convergence of the network, this will aggravate the over-fitting of the network under the condition of the network overfitting, especially when there are a large number of training samples.

In view of this, the invention proposes a label learning method based on random smooth update. Firstly, the label distribution is reconstructed in a smooth way instead of using Formula (10); secondly, the labels are updated only in the preset training rounds, and random factors are introduced to keep the original labels with a certain probability. Moreover, in an exemplary embodiment, the generative network, the discriminant network, the loss function module and the label learning module are software modules stored in one or more memories and executable by one or more processors coupled to the one or more memories.

### Example 2

Experimental Settings:

Experimental environment: the code is written by Pytorch framework and runs on a server equipped with two Nvidia TITAN Xp graphics cards.

Generative network: The generative network adopts a U-Net structure, the Encoder consists of 8 convolution modules, and correspondingly, the Decoder consists of 8 deconvolution modules, wherein the convolution kernel for convolution and deconvolution operation has a size of 4*4 and a step size of 2. Since jump connections are added to the U-Net structure, the number of channels will change correspondingly (the modules without jump connections will not change). The channel number is set as shown in Table 1.

TABLE 1

| Module No. | 1 | 2 | 3 | 4 | 5 | 6 | 7 | 8 |
|---|---|---|---|---|---|---|---|---|
| Convolution | 64 | 128 | 256 | 512 | 512 | 512 | 512 | 512 |
| Module | | | | | | | | |
| Deconvolution | 512 | 1024 | 1024 | 1024 | 1024 | 512 | 256 | 64 |
| Module | | | | | | | | |

Discriminant network: The Markov discriminator consists of four convolution modules that outputs a feature map with the receptive field of 70*70, and is set up similarly to the generative module, i.e. the convolution operation is based on a convolution kernel size of 4*4 and a step size of 2, and the number of channels is 64→128→256→512 in turn. The first convolution module does not incorporate a BatchNorm structure. The multi-scale discriminator firstly uses 1*1 convolution to increase the number of channels of input features to 256, then the number of channels of each group of features is 64, the convolution kernel size of convolution operation is 3*3*64 with a step size of 1.

Loss function: In terms of loss function, some training data are selected for interval search according to the invention, where, αₛ and are αₗ 0.6 and 0.4 respectively, λ₁ and λ₂ are 0.05 and 0.3 respectively.

Data preprocessing: According to the invention, the pixels of all images are normalized to the interval [−1,1], and the image size is uniformly scaled to 256*256. In the setting of occluded block, the occluded block is set to be rectangular, and the ratio coefficient of length and width is randomly selected in an interval [0.1, 0.4]. The RGB channel value of the occluded part is replaced by the average value on the RGB channel of the corresponding dataset, as shown in FIG. 3.6.

Training Strategy:

In the training of the GAN network, BatchSize is set to 1, training is carried out for 20 rounds, Adam is used as an optimizer, the learning rate is 0.0002, and momentum parameters β₁=0.5, β₂=0.999.

Since the GAN network only generates images, data can only be enhanced on a person identification model. According to the invention, the Densenet-121 network is used as the baseline of the identification model, and the network is followed by a fully connected layer for classification. In the training of the identification network, BatchSize is set to 64, training is carried out for 60 rounds, and SGD with momentum is used as an optimizer with the learning rate of 0.01, the momentum parameter of 0.9, and the learning rate decay parameter of 0.0004.

Before the generative image is used for expanding datasets, the value of the number of expanded images M shall be determined. According to the invention, combined with the Market-1501 dataset, a parameter comparison experiment is carried out in a single query mode, and parameters are selected.

The experimental results of expanding the number of images M are shown in Table 2 and FIG. 6. The Market-1501 dataset contains 12936 images, and the original dataset is expanded according to the ratio of 0, 1, 1.5, 2 and 2.5 in turn according to the invention. It can be seen that when the same number of images (12936) are used to expand data, the identification effect of the baseline model is the best, with mAP of 79.9% and Rank-1 of 92.7%. The identification effect will decrease with the increase of the number of expanded images though, which, as described in the invention, results from some noise contained in the generative image, because the introduction of too much noise will affect the convergence of the model. However, compared with the baseline model, there is still a significant improvement.

TABLE 2

| M | mAP | Rank-1 |
|---|---|---|
| 0(baseline) | 73.6 | 89.7 |
| 12936 | 79.9 | 92.7 |
| 19404 | 79.6 | 92.2 |
| 25872 | 79.2 | 91.9 |
| 32340 | 78.5 | 91.6 |

After it is determined that M=12936, comparison experiments are carried out on three datasets: Marke-1501, CUHK03 and DukeMTMC-relD.

The experimental results on Market-1501 dataset are shown in Table 3, in which Ours stands for the method proposed by the invention. It can be seen that the identification effect of the model is obviously improved and is superior to the pix2pix network after the images generated by the multi-scale generative adversarial network are added. Compared with the baseline model, mAP, Rank-1 and Rank-5 increase by 6.3%, 3.0% and 0.9% respectively in the Single Query test mode; whereas, mAP and Rank-1 increase by 5.1% and 3.6% respectively in the Multi Query test mode.

TABLE 3

| | Single Query | | | Multi Query | | |
|---|---|---|---|---|---|---|
| Method | mAP | Rank-1 | Rank-5 | mAP | Rank-1 | Rank-5 |
| DenseNet(baseline) | 73.6 | 89.7 | 96.6 | 80.0 | 91.9 | 97.2 |
| DenseNet + pix2pix | 77.5 | 91.5 | 97.4 | 83.8 | 93.8 | 97.9 |
| Ours | 79.9 | 92.7 | 97.5 | 85.1 | 94.5 | 97.8 |

The experimental results on CUHK03 (labeled) dataset are shown in Table 4. Compared with the baseline model, mAP, Rank-1 and Rank-5 increase by 7.6%, 8.2% and 4.9% respectively in the Single Query test mode.

TABLE 4

| Method | mAP | Rank-1 | Rank-5 |
|---|---|---|---|
| DenseNet(baseline) | 42.4 | 44.7 | 65.9 |
| DenseNet + pix2pix | 48.1 | 51.2 | 70.2 |
| Ours | 50.1 | 52.9 | 70.8 |

The experimental results on DukeMTMC-relD dataset are shown in Table 5. Compared with the baseline model, mAP, Rank-1 and Rank-5 increase by 7.0%, 5.1% and 2.3% respectively in the Single Query test mode.

TABLE 5

| Method | mAP | Rank-1 | Rank-5 |
|---|---|---|---|
| DenseNet(baseline) | 62.9 | 79.4 | 89.7 |
| DenseNet + pix2pix | 67.9 | 82.2 | 91.4 |
| Ours | 69.9 | 84.5 | 92.0 |

From the above experimental results, it can be seen that the identification effect of the baseline model on each dataset is obviously improved after the images generated by multi-scale generative adversarial network are added; and compared with the images generated by the pix2pix network, the identification effect of the images generated by multi-scale generative adversarial network is significantly improved. This is because the multi-scale generative adversarial network optimizes the structure of the generative network, and increases the results of multi-scale discriminators to enhance the quality of generative images.

Experimental Results of Label Learning:

The experimental parameters are set the same as above, and the hyperparameter ε is set to 0.15.

The experimental results on Market-1501 dataset are shown in Table 6, in which Ours represents the structure of the multi-scale generative adversarial network proposed by the invention. LSR and MPRL respectively represent the label smoothing method and the improved MPRL proposed by the invention. It can be seen that after the introduction of label learning method, the model identification effect has been improved to some extent, wherein the improved MPRL is obviously better than the LSR method. Compared with the LSR model, mAP and Rank-1 increase by 1.4% and 0.8% respectively in the Single Query test mode; whereas, mAP, Rank-1 and Rank-5 increase by 1.9%, 0.7% and 0.3% respectively in the Multi Query test mode.

TABLE 6

| | Single Query | | | Multi Query | | |
|---|---|---|---|---|---|---|
| Method | mAP | Rank-1 | Rank-5 | mAP | Rank-1 | Rank-5 |
| DenseNet(baseline) | 73.6 | 89.7 | 96.6 | 80.0 | 91.9 | 97.2 |
| DenseNet + pix2pix | 77.5 | 91.5 | 97.4 | 83.8 | 93.8 | 97.9 |
| Ours | 79.9 | 92.7 | 97.5 | 85.1 | 94.5 | 97.8 |
| Ours + LSR | 80.1 | 92.8 | 97.5 | 85.2 | 94.5 | 97.2 |
| Ours + MPRL | 81.5 | 93.6 | 97.4 | 87.0 | 95.2 | 97.5 |

The experimental results on CUHK03 (labeled) dataset are shown in Table 7. Compared with the LSR method, the improved MPRL improves mAP, Rank-1 and Rank-5 by 2.1%, 1.7% and 0.7% respectively in Single Query test mode.

TABLE 7

| Method | mAP | Rank-1 | Rank-5 |
|---|---|---|---|
| DenseNet(baseline) | 42.4 | 44.7 | 65.9 |
| DenseNet + pix2pix | 48.1 | 51.2 | 70.2 |
| Ours | 50.1 | 52.9 | 70.8 |
| Ours + LSR | 51.8 | 53.0 | 70.3 |
| Ours + MPRL | 53.9 | 54.7 | 71.0 |

The experimental results on DukeMTMC-relD dataset are shown in Table 8. Compared with the LSR method, the improved MPRL increases mAP, Rank-1 and Rank-5 by 2.1%, 0.8% and 0.6% respectively in Single Query test mode.

TABLE 8

| Method | mAP | Rank-1 | Rank-5 |
|---|---|---|---|
| DenseNet(baseline) | 62.9 | 79.4 | 89.7 |
| DenseNet + pix2pix | 67.9 | 82.2 | 91.4 |
| Ours | 69.9 | 84.5 | 92.0 |
| Ours + LSR | 70.2 | 84.9 | 92.2 |
| Ours + MPRL | 72.3 | 85.7 | 92.8 |

According to the above experimental results, the introduction of label learning method can improve the identification effect of the model. The improved MPRL is more effective than LSR method, and outperforms the LSR method in terms of evaluation indexes on all datasets. This is due to the fact that the improved MPRL no longer uses fixed labels allocated offline, but learns dynamically during training, optimizing the probability distribution of labels as network parameters are updated.

The invention firstly points out common problems of generative adversarial networks at present, then introduces the pix2pix network framework, and on the basis of this, puts forward a multi-scale conditional generative adversarial network structure, and explains the network principle from three aspects of generative network, discriminant network and loss function. Further, experiments on public datasets show that the structure is effective. Then two label allocation modes are introduced, i.e. offline learning-based LSR method and online learning-based MPRL, and the experimental results on several datasets demonstrate the superiority of the improved MPRL. Moreover, in an exemplary embodiment, the generative network, the discriminant network, the loss function module and the label learning module are software modules stored in one or more memories and executable by one or more processors coupled to the one or more memories.

The preferred embodiments described herein are only for illustration purpose, and are not intended to limit the invention. Various modifications and improvements on the technical solution of the invention made by those of ordinary skill in the art without departing from the design spirit of the invention shall fall within the scope of protection as claimed in claims of the invention.

What is claimed is:

1. A person re-identification system integrating multi-scale GAN (Generative Adversarial Network) and label learning, wherein the system comprises a generative network, a discriminant network, a loss function module and a label learning module, and the generative network is connected to the discriminant network;
wherein the generative network comprises a U-Net sub-network for restoring occluded images and expanding datasets;
wherein the discriminant network comprises a Markov discriminator and a multi-scale discriminator;
wherein the Markov discriminator is configured for extracting regional features;
wherein the multi-scale discriminator is configured for extracting multi-scale features;
wherein the generative network is configured for inputting an occluded image added to an original image and outputting a generative image; and
wherein the discriminant network is configured for inputting the generative image and the original image.

2. The person re-identification system integrating multi-scale GAN and label learning as claimed in claim 1, wherein the generative network uses an Encoder-Decoder structure; an Encoder of the Encoder-Decoder structure comprises a plurality of first convolutional layers, and the first convolutional layer is configured for downsampling and encoding an input; an Decoder of the Encoder-Decoder structure comprises a plurality of deconvolutional layers, and the deconvolutional layer is configured for upsampling and encoding encoded information.

3. The person re-identification system integrating multi-scale GAN and label learning as claimed in claim 2, wherein the U-Net sub-network is further configured for adding jump connections between the Encoder and the Decoder, and the jump connection between first two layers are deleted from the U-Net sub-network.

4. The person re-identification system integrating multi-scale GAN and label learning as claimed in claim 2, wherein the convolutional layer and the deconvolutional layer adopt the same convolution kernel with a size of 4 and a step size of 2.

5. The person re-identification system integrating multi-scale GAN and label learning as claimed in claim 1, wherein the Markov discriminator comprises a plurality of second convolutional layers, a batch normalization layer and an activation function; the second convolutional layer is configured for downsampling the original image, reducing a size of feature map and increasing a receptive field at each location; the activation function is Sigmoid; and the Markov discriminator is configured for discriminating the same region once or many times.

6. The person re-identification system integrating multi-scale GAN and label learning as claimed in claim 1, wherein the loss function module comprises a GAN loss, an L1 norm loss and a feature matching loss;
wherein the GAN loss is configured for optimizing the ability of the discriminant network to discriminate the authenticity of an image; and the L1 norm loss and the feature matching loss are configured for reducing a difference between the generative image and a target image in pixel dimension and feature dimension.

7. The person re-identification system integrating multi-scale GAN and label learning as claimed in claim 1, wherein the label learning module uses an improved multi-pseudo regularized label for label learning, with improvements as follows: constructing a label distribution in a smoothed manner, updating labels in preset training rounds, introducing random factors while updating, and retaining some of original labels based on the random factors.

8. A person re-identification method integrating multi-scale GAN and label learning, wherein the method specifically comprises the following steps:
S1, constructing a multi-scale conditional generative adversarial network, wherein the multi-scale conditional generative adversarial network comprises a generator and a discriminator, acquiring an original person image, performing normalization processing, and adding an occlusion to the original person image to obtain an occluded person image;
S2, inputting the occluded person image to the generator that restores the occluded person image and outputs a generative image; and adding a label to the generative image for label learning;
S3, inputting the labeled generative image and the original person image into the discriminator, wherein the discriminator extracts feature regions and multi-scale features from the labeled generative image, calculates comparison results between the extracted feature regions, the multi-scale features and the original person image based on a loss function, obtains loss values, and optimizes and updates parameters of the generator based on the loss function; and
S4, iterating S3 until the number of iterations reach a preset value, then completing the person re-identification.

9. The person re-identification method integrating multi-scale GAN and label learning as claimed in claim 8, wherein a specific method of label learning is to conduct online label learning through an improved MPRL (Multi-pseudo Regularized Label), and reduce noise interference caused by the generative image.
